(19) United States
(12) Patent Application Publication
(10) Pub. No.: US 2007/0112954 A1
(43) Pub. Date: May 17, 2007

(54) Efficiently detecting abnormal client termination

(75) Inventors: Ramkumar Ramani, Sunnyvale, CA (US); Seung-Ho Cho, Santa Clara, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/274,432

(22) Filed: Nov. 15, 2005

(51) Int. Cl. G06F 15/173

(52) U.S. Cl. 709/224

(57) ABSTRACT

The invention is directed to managing an abnormal client termination of a network connection with a server. When a client establishes a connection with the server, the server provides various heartbeat values to the client. The server may also send heartbeat values at various other times based on a variety of factors. Heartbeat values may be based on a network load, a CPU load, or the like, as well as different states of the client. For example, one heartbeat value may be used when the client is in an idle state. Other heartbeat values may be used when the client is engaged in a VOIP session, in a videoconferencing session, a streaming video session, or the like. When the client changes state, a different heartbeat value may be used to automatically modify a frequency for sending the heartbeat signal to the server.

### BACKGROUND OF THE INVENTION

The present invention relates generally to network communications, and more particularly, but not exclusively, to a system and method for managing a detection of an abnormal client termination using an automatically determined heartbeat value that is based, in part, on a client state.

In today's networking infrastructures, a client-server implementation is a commonly used networking application architecture. In the client-server implementation, the client is typically separate from the server. This implementation is a very scalable approach that may be arranged to allow a single server to service requests from many clients. When a client makes a connection to the server, it may consume a portion of the server's resources. When a client is ready, it may provide a connection termination request to the server acknowledging that it no longer requests the server's resources. In some instances, the server may then record how much of the resources were consumed. This record may be useable for such activities as billing a client for its resource consumption.

However, when a client abnormally terminates, perhaps due to a client crash, power failure, network failure, or the like, the server may not then know that the resources are no longer being requested by the client. This may sometimes result in the resource being allocated to the client beyond the abnormal termination. Such allocation results in wasting of server resources. In addition, it may also result in an improper recording of the client's consumption of the resources. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be included in a system implementing the invention;

FIG. 3 shows one embodiment of a server device that may be included in a system implementing the invention; and

FIG. 4 illustrates a logical flow diagram generally showing one embodiment of a server process for managing a detection of an abnormal client termination based on a client state; and

FIG. 5 illustrates a logical flow diagram generally showing one embodiment of a client process for managing a detection of an abnormal client termination based on a client state, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The terms “network connection” and “connection” refer to a collection of links, software elements, and communication protocols that enable a computing device to communicate with another computing device over a network. Establishing a connection may arise through a request for the connection using any of a variety of communication protocols. For example, one such network connection may be a TCP connection. TCP connections are virtual connections between two network devices, and are typically established through a TCP handshake protocol. The TCP protocol is described in more detail in Request for Comments 793, which is available at http://www.ietf.org/rfc/rfc0793.txt?number=793. The present invention however, is not limited to TCP network connections. For example, although known as a connectionless protocol, a UDP network “connection” can also be employed. Network connections may be employed to support various communication sessions. Such communication sessions may include, but are not limited to, VOIP sessions, IM sessions, SMS sessions, email sessions, videoconferencing sessions, streaming media sessions, or the like.

The term “client state” as used herein refers to a status, condition, process, transaction, or setting, of the client. One client state includes an idle state where the client may be viewed as not actively sending network packets over a network. Other client states include, but are not limited to being in a particular session, such as a VOIP session call, an IM session, an SMS session, or the like. In one mode, a start of a client state may be determined by a sending of a request to transition into that client state. For example, the VOIP session call client state may be said to be the current client state, when a VOIP call request is received by a server, and said to be no longer the current client state when a VOIP call cancel message is received by the server. In one embodiment then, the server may receive and maintain information indicating a client state, and/or a request to transition to a different client state.

As used herein, the term “heartbeat” refers to any periodic or quasi-periodic signal that may be employed to indicate a presence of the device sending the heartbeat signal. The sending device may use a variety of mechanisms to provide the heartbeat signal. For example, in one embodiment, the heartbeat signal may be a specially defined packet, a ping message, or the like. In one embodiment, the heartbeat signal is a TCP keep-alive packet.

Briefly stated, the present invention is directed towards a system, method, and apparatus for managing an abnormal client termination of a network connection with a server. When a client establishes a network connection with a server, the server provides various heartbeat values to the client. In one embodiment, the server may also send another heartbeat value to the client at various times while the client is still connected to the server, based on a variety of factors. Heartbeat values may be used to determine a frequency for sending a heartbeat signal to the server. Receipt of the heartbeat signal within a given frequency enables the server to determine, at least in part, whether the client has abnormally terminated.

The various heartbeat values may be based on a variety of factors, including, but not limited to, a network load at the server, a load at the server for a particular session type, a CPU load on the server, a number of active network connections being managed by the server, or other resource load. Moreover, the various heartbeat values may include a value for different states of the client, including various sessions, activities, or inactivity states. For example, in one embodiment, one heartbeat value may be used when the client is determined to be in an idle state. In another embodiment, another heartbeat value may be used to determine how often to send the heartbeat signal when the client is engaged in a VOIP session. The invention is not limited to these states, however. For example, the frequency of the heartbeat signal may be automatically modified by the client based on other states, including a videoconferencing session state, a streaming video state, or the like. When the client detects that it is in a different client state, the client may automatically employ a different heartbeat value based on the different client state. By employing different heartbeat values based, in part on a client state, and/or conditions monitored by the server, an improvement in the use of network resources may be achieved, including improvements in bandwidth, CPU resources, or the like. Moreover, by detecting an abnormal failure earlier, the invention may be able to terminate sessions sooner and thereby provide more accurate accounting information associated with sessions, and improve resource usage.

Illustrative Operating Environment

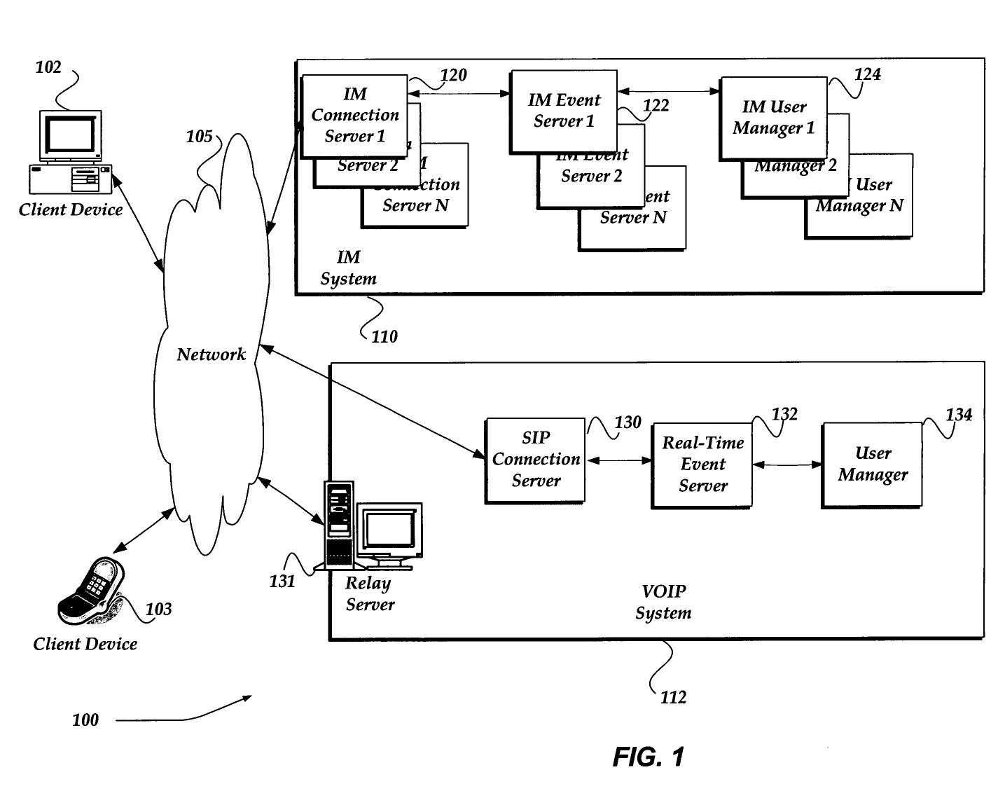

FIG. 1 illustrates one embodiment of an environment in which the present invention may operate. However, not all of these components may be required to practice the invention, and variations in the arrangement and type of the components may be made without departing from the spirit or scope of the invention. Moreover, although the invention illustrates an instant messaging (IM)/VOIP environment, the invention is not so limited, and another environment may also be employed to practice the invention.

As shown in the figure, however, system 100 includes client devices 102-103, network 105, IM system 110, and VOIP system 112. IM system 110 may include IM connection servers 120, IM event servers 122, and IM user managers 124. VOIP system 112 includes relay server 131, SIP connection server 130, real-time event server 132, and user manager 134.

Client device 102 is in communication with IM connection servers 120, SIP connection server 130, and relay server 131 through network 105. Client device 103 is in communication with IM connection servers 120, SIP connection server 130, and relay server 131 through network 105. IM event servers 122 are in communication with IM connection servers 120 and IM user managers 124. Real-time event server 132 is in communication with SIP connection server 130 and user manager 134.

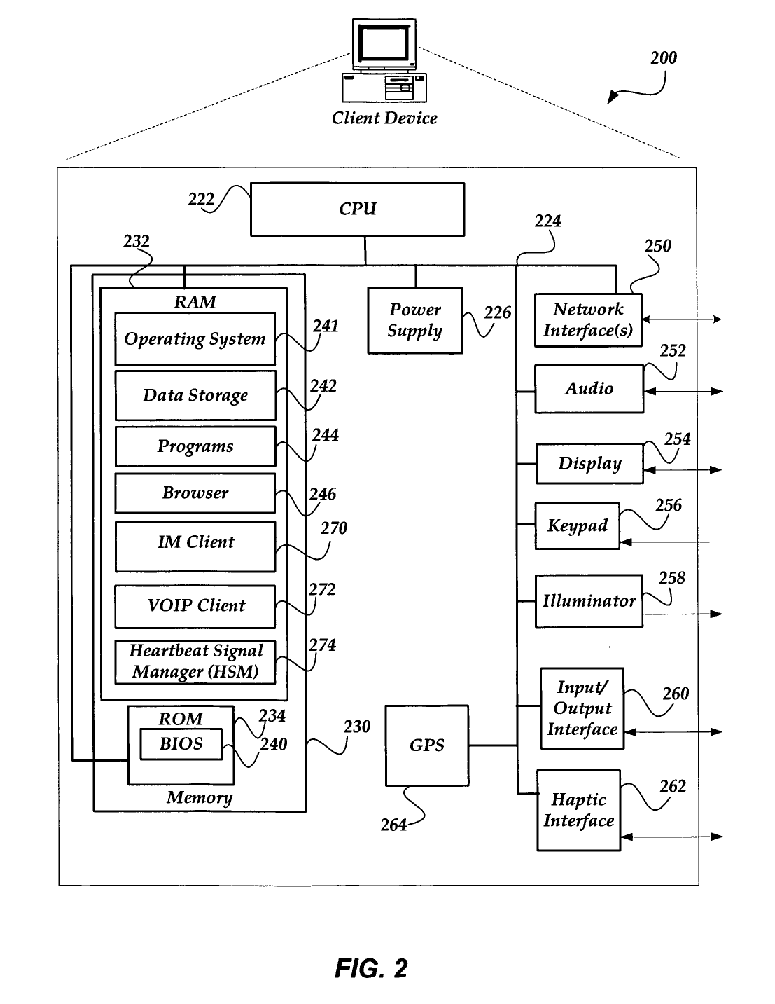

One embodiment of client devices 102-103 is described in more detail below in conjunction with FIG. 2. Briefly, however, client devices 102-103 may include virtually any device that is arranged to send and receive communications and messages such as IM messages, VOIP messages, or the like, via one or more wired and/or wireless communication interfaces. For example, client device 103 may be configured to send and/or receive VOIP messages with client device 102 through VOIP system 112, and IM messages through IM system 110.

Typically, client devices 102-103 may be configured to communicate using any of a variety of protocols. For example, client devices 102-103 may be configured to employ RTP for communicating media data such as audio and video to another device. However, the invention is not so limited, and another media data mechanism may be employed, including IAX, and the like. Client devices 102-103 may also employ the SIP protocol for enabling setting up a session and enabling such actions as dialing a number, enabling a ring, a ring-back tone, busy signal, and the like. However, other signaling protocols may also be employed, including H.323, Skinny Client Control Protocol (SCCP), IAX, MiNET, and the like. Typically, however, client devices 102-103 may employ SIP over either UDP or TCP and RTP over UDP.

Client devices 102-103 may include a client application that enables a VOIP connection such that a VOIP call from another computing device may result in establishing an active VOIP session over a connection. The client devices in the active VOIP session may be said to be in a current client state of a VOIP session call.

Moreover, the client application may provide a message indicating that the VOIP session with the caller is active. In one embodiment, the client application may be an IM client application. In another embodiment, the client application is a component of an application, such as the IM client application, or the like. However, the invention is not so limited, and the client application may be a separate application that may also interact with an IM application, a VOIP application, or the like.

In addition, client devices 102-103 may also be configured to provide an identifier, sometimes known as an originating line identifier (OLI) during a communication. The identifier may employ any of a variety of mechanisms, including a device model number, a carrier identifier, a mobile identification number (MIN), and the like. The MIN may be a telephone number, a Mobile Subscriber Integrated Services Digital Network (MS-ISDN), an electronic serial number (ESN), or other device identifier. The OLI may also be an IP address associated with client devices 102-103. In one embodiment, the identifier is provided with each communication. In another embodiment, the identifier is provided by an end-user. In one embodiment, the identifier may be associated with a user.

Client devices 102-103 may also include another client application that provides a heartbeat signal to a server device indicating that a network connection with the server should be considered as alive. Such heartbeat signals may be used to minimize a likelihood that the server determines that the client device has abnormally terminated due to a variety of conditions, including power failures, a locked client application, a failed client device, a network failure, or the like. The client application may receive from a server device various heartbeat values each of which may be associated with a different client state. The application may then select a heartbeat value based, in part, on a client state, for use in setting a frequency in which to send the heartbeat signal.

Devices that may operate as client devices 102-103 include devices that typically connect using a wired communications medium such as personal computers, desktop computers, multiprocessor systems, microprocessor-based or programmable consumer electronics, network PCs, and the like. The set of such devices may also include devices that typically connect using a wireless communications medium such as cell phones, smart phones, pagers, walkie talkies, Personal Digital Assistants (PDAs), handheld computers, programmable consumer electronics, an IP phone, radio frequency (RF) devices, infrared (IR) devices, CBs, integrated devices combining one or more of the preceding devices, or virtually any mobile device, and the like. Similarly, client devices 102-103 may be any device that is capable of connecting using a wired or wireless communication medium such as a PDA, POCKET PC, wearable computer, and any other device that is equipped to communicate over a wired and/or wireless communication medium.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 may include any communication method by which information may travel between computing devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

IM system 110 is configured to manage IM sessions between client devices employing an IM client application. IM system 110 may employ IM connection servers 120, IM event servers 122, and IM user managers 124 to manage one or more IM sessions. In one embodiment, IM connection servers 120, IM event servers 122, and IM user managers 124 may represent separate server processes operating with a single computing device. In another embodiment, IM connection servers 120, IM event servers 122, and IM user managers 124 may represent distinct processes operating across multiple computing devices. As such, IM system 110 may be implemented on a variety of computing devices including personal computers, desktop computers, multiprocessor systems, microprocessor-based devices, network PCs, servers, network appliances, and the like.

IM connection servers 120 are configured to receive a request to establish an IM session from an IM client, such as might be included within client devices 102-103, and the like. IM connection servers 120 may also receive from the IM client authentication information that may be employed to authenticate an end-user of the IM client. If the end-user is authenticated, IM connection servers 120 may enable the IM client to log into the IM session. IM connections servers 120 may also be configured to provide information about the established session to IM event servers 122.

IM connections servers 120 may also forward various request information from the IM client to IM event servers 122. Such request information may include, for example, a request to locate and communicate with another IM end-user.

IM event servers 122 are configured to receive the end-user's log in and other request information from IM connections servers 120.1M event servers 122 may request IM user managers 124 to store information about the IM client and end-user. IM user mangers 124 may employ a table, spreadsheet, file, database, and the like, to register the IM client, and on which IM connection server, within IM connection servers 120, the IM client is logged into. Thus, IM user managers 124 may store information about various IM conversations that may include such information as identifiers for end-users associated with an IM conversation, time information, account identifiers for the end-users, IM connection servers associated with an IM conversation, and so forth. As such, IM event servers 122 may also employ IM user managers 124 to determine which IM connection server, within IM connection servers 122, another end-user is logged into, and provide such information to IM connection servers 120, so that an IM session may be established between two or more IM end-users.

VOIP system 112 is configured to manage VOIP sessions between client devices using any of a variety of VOIP protocols. As shown, VOIP system 112 may be implemented in a single computing device, with each of the illustrated components operating as one or more processes with the single computing device. VOIP system 112 may also be implemented across multiple computing devices, with one or more of the illustrated components distributed across the multiple computing devices. As such VOIP system 112 may be implemented on a variety of computing devices including personal computers, desktop computers, multiprocessor systems, microprocessor-based devices, network PCs, servers, network appliances, and the like.

Relay server 131 is configured to manage messages, such as media messages between one computing device and another, such as client devices 102-103, and the like. Relay server 131 may, for example, receive a VOIP packet, such as a TCP/IP packet and relay it towards a destination device. Relay server 131 may also be configured to monitor flow congestion, quality of service characteristics, and the like, associated with a communication between itself and the destination device, and/or the source device. Devices that may operate as relay server 131 include personal computers, desktop computers, multiprocessor systems, microprocessor-based or programmable consumer electronics, network PCs, servers, firewalls, gateways, network address translators, bridges, routers, and the like.

SIP connection server 130 is configured to receive a request to establish a SIP connection from client devices 102-103, and the like. The requesting device may provide identification information to SIP connection server 130 that may be used, at least in part, to authenticate the request to establish the SIP connection. If the requesting device is authenticated, SIP connection server 130 may enable the requesting device to log into a connection. SIP connection server 130 may also provide information about the requesting device to real-time event server 132. Real-time event server 132 may be configured to receive the information and provide it to user manager 134 for storage.

SIP connection server 130 may receive a heartbeat signal from a client device to validate that the client device is still active and that its connection is not abnormally terminated. SIP connection server 130 may determine various client states that client devices 102-103 may be in. In one embodiment, SIP connection server 130 is provided with a pre-determined set of likely client states, including at least one default client state to cover unlikely client states.

SIP connection server 130 may also provide the heartbeat values to a client device when it initially connects to the server. However, the invention is not so limited, and the heartbeat values may also be sent to the client device based on a change in a condition, periodically, or the like.

SIP connection server 130 may then determine a heartbeat value for each of the various client states. For example, SIP connection server 130 may determine that a reasonable heartbeat value for a VOIP session call state is between about 30 seconds, while a heartbeat value for an idle client state might be about 13 minutes. However, the invention is not so limited, and a variety of other values may be selected as heartbeat values for idle and/or VOIP session call client states.

For example, SIP connection server 130 may determine a heartbeat value based on a network load, a CPU resource load, a number of clients currently active, or other resource load. Based on such resource load determinations, SIP connection server 130 may vary the heartbeat values. For example, in one embodiment, SIP connection server 130 may set the heartbeat value during one load condition at about 20 seconds, while at another load condition the heartbeat value may be set to about 30 seconds.

SIP connection server 130 may determine a state in which a client device is in, and based, in part, on the determined client state, monitor for a heartbeat signal to be received at a frequency associated with the determined client state. In one embodiment, SIP connection server 130 may store information associated with which state a client device is in. Use of the stored client state information may then be employed by SIP connection server 130 to determine whether the client device has changed its client state.

Although SIP connection server 130 is described as providing the heartbeat values, and monitoring for the heartbeat signals, the invention is not so limited. For example, other networked devices may also provide the heartbeat values, and/or monitor for the heartbeat signals. In one embodiment, different networked devices may be employed, one for providing the heartbeat values, and another for monitoring for the heartbeat signals, without departing from the scope or spirit of the invention.

User manager 134 may store the information in a database, spreadsheet, table, file, and the like. Such information may include, for example, an identifier associated with the requesting device, an end-user associated with the requesting device, an address associated with SIP connection server 130, and the like. User manager 134 may receive and manage such information for a plurality of requesting devices. User manager 134 may also provide information to real-time event server 132 about at least one other requesting device, such that SIP connection server 130 may enable a VOIP communication between one or more end-user devices, such as client devices 102-103, and the like. In one embodiment, the one or more end-user devices may employ relay server 131 to relay the VOIP communications between them. For example, SIP connection server 130 may provide a token, certificate, ticket, or similar authentication/authorization mechanism, to the one or more client devices. The one or more client devices may then provide the authentication/authorization mechanism to relay server 131 to establish the communications.

Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention.

As shown in the figure, client device 200 includes a processing unit 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or the like.

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

Programs 244 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, codec programs, and so forth. In addition, mass memory 230 stores browser client 246, IM client 270, VOIP client 272, and Heartbeat Signal Manager (HSM) 274.

Browser 246 may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

VOIP client 272 is configured to enable client device 200 to initiate, receive, and manage a VOIP session with another client device. VOIP client 272 may employ the SIP protocol for managing signaling, and RTP for transmitting the VOIP traffic (“media”). However, the invention is not so constrained, and any of a variety of other VOIP protocols may be employed including IAX which carries both signaling and voice data, H.323, SCCP, Megaco, MGCP, MiNET, Skinny Client Control Protocol (SCCP), and the like. VOIP client 272 is further configured to employ virtually any media codec to compress the media stream for communicating it over the network, including G.711, G.729, G.729a, iSAC, Speex, and the like. In one embodiment, SIP may be employed to enable a Session Description Protocol (SDP).

VOIP client 272 may be further configured to manage a flow of VOIP packets to and/or from another computing device. In one embodiment, VOIP client 272 may employ these components to provide the packets using RTP with Real-time Control Protocol (RTCP). VOIP client 272 may employ an RTCP report from a destination device to determine various qualities of communications, including flow control, congestion control, quality of service, and the like.

IM client 270 may be configured to initiate and manage an instant messaging session, including, but not limited to AOL Instant Messenger, Yahoo! Messenger, NET Messenger Server, ICQ, and the like. In one embodiment, IM client 270 is configured to employ a VOIP client, such as VOIP client 272 to integrate IM/VOIP features. Thus, in one embodiment, IM client 270 may employ SIP to establish media sessions with another computing device employing an IM/VOIP capable client, and RTP to communicate the media traffic. However IM client 270 is not so limited. For example, IM client 270 may also employ any of the following SIMPLE (SIP for Instant Messaging and Presence Leverage), APEX (Application Exchange), Prim (Presence and Instant Messaging Protocol), the open XML-based XMPP (Extensible Messaging and Presence Protocol), more commonly known as Jabber and OMA (Open Mobile Alliance)'s IMPS (Instant Messaging and Presence Service) created specifically for mobile devices, and the like.

HSM 274 may be arranged to provide heartbeat signals to one or more servers. The heartbeat signals may be sent using virtually any of a variety of mechanisms, including a dedicated network packet, a keep alive packet, a ping message, or the like.

HSM 274 may receive a plurality of heartbeat values from a server, where each of the heartbeat values may be associated with a different client state. In one embodiment, HSM 274 may receive at least one heartbeat value when client device 200 establishes a connection with the server. In another embodiment, HSM 274 may receive at least one heartbeat value at different times during the established connection with the server.

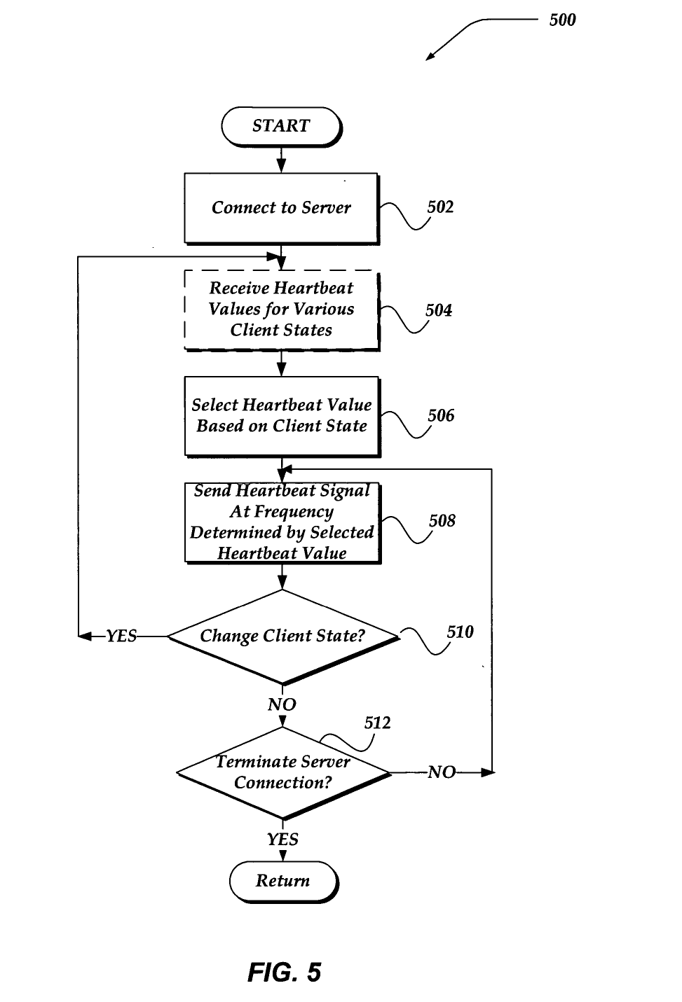

Based on a client state, HSM 274 may select a heartbeat value and send the heartbeat signal based on a frequency determined from the selected heartbeat value. When the client state changes HSM 274 may select a different heartbeat value based on the new client state. Thus, HSM 274 may send heartbeat signals to the server(s) at different frequencies, based on the client state. If client device 200 returns to a first client state, HSM 274 may employ the heartbeat value for the first client state and send heartbeat signals based on that value. HSM 274 may employ a process substantially similar to process 500 described below in conjunction with FIG. 5 to perform at least some of its actions.

In one embodiment, HSM 274 may also determine a plurality of heartbeat values based on various client states. In this instance, HSM 274 may provide the plurality of heartbeat values to the server.

Illustrative Server Environment

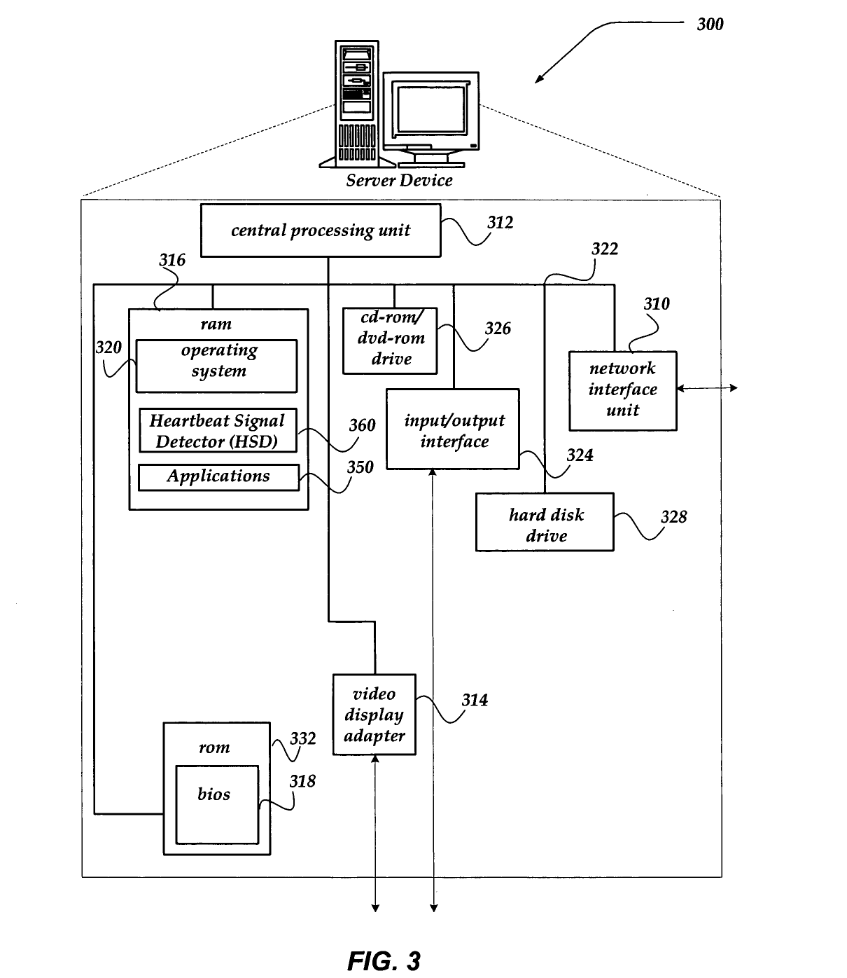

FIG. 3 shows one embodiment of a server device, according to one embodiment of the invention. Server device 300 may include many more components than those shown. The components shown, however, are sufficient to disclose an illustrative embodiment for practicing the invention. Server device 300 may be, for example, SIP connection server 130 of FIG. 1.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of server device 300. Any general-purpose operating system may be employed. Basic input/output system (“BIOS”) 218 is also provided for controlling the low-level operation of server device 300. As illustrated in FIG. 3, server device 300 also can communicate with the Internet, or some other communications network, such as network 105 in FIG. 1, via network interface unit 310, which is constructed for use with various communication protocols including the TCP/IP protocol. Network interface unit 310 is sometimes known as a transceiver, transceiving device, network interface card (NIC), and the like.

Server device 300 may also include an SMTP handler application for transmitting and receiving email. Server device 300 may also include an HTTP handler application for receiving and handing HTTP requests, and an HTTPS handler application for handling secure connections. The HTTPS handler application may initiate communication with an external application in a secure fashion.

Server device 300 also includes input/output interface 324 for communicating with external devices, such as a mouse, keyboard, scanner, or other input devices not shown in FIG. 3. Likewise, server device 300 may further include additional mass storage facilities such as CD-ROM/DVD-ROM drive 326 and hard disk drive 328. Hard disk drive 328 is utilized by server device 300 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs include email programs, schedulers, calendars, transcoders, database programs, word processing programs, spreadsheet programs, and so forth. Mass storage may further include applications such as Heartbeat Signal Detector (HSD) 360.

HSD 360 may be configured to provide a client device various heartbeat values each being associated with a different client state, and to monitor a heartbeat signal for detection of an abnormal client termination. HSD 360 may employ a variety of mechanisms to determine the heartbeat values for each client state, including, determining the heartbeat values based on a CPU load, a network client, a number of client connections, a client state, or other resource load.

HSD 360 may provide the various heartbeat values to the client when the client initially establishes a connection with a server device. HSD 360 may also provide at least one heartbeat value during the established connection based on a change in a condition, such as a change in a load, or the like. HSD 360 may provide one heartbeat value for one client state to one client device and a different heartbeat value for the same client state to a different client device. This may occur for a variety of reasons, including how often HSD 360 selects to send heartbeat values to client devices, or the like.

HSD 360 may then receive information indicating which client state a client is in, and based, in part, on that client state, monitor receipt of a heartbeat signal from the client to determine whether the heartbeat signals are received within an associated heartbeat value. In one embodiment, HSD 360 receives the client state information from another component of server device 300. However, HSD 360 may also receive the client state information from another server device, or even from the client itself.

In one embodiment, HSD 360 may employ a tolerance of acceptance upon its monitoring of the frequency of heartbeat signals to minimize false positive type of detections of abnormal client terminations. Such tolerance may vary based on a client state, a resource load, or the like.

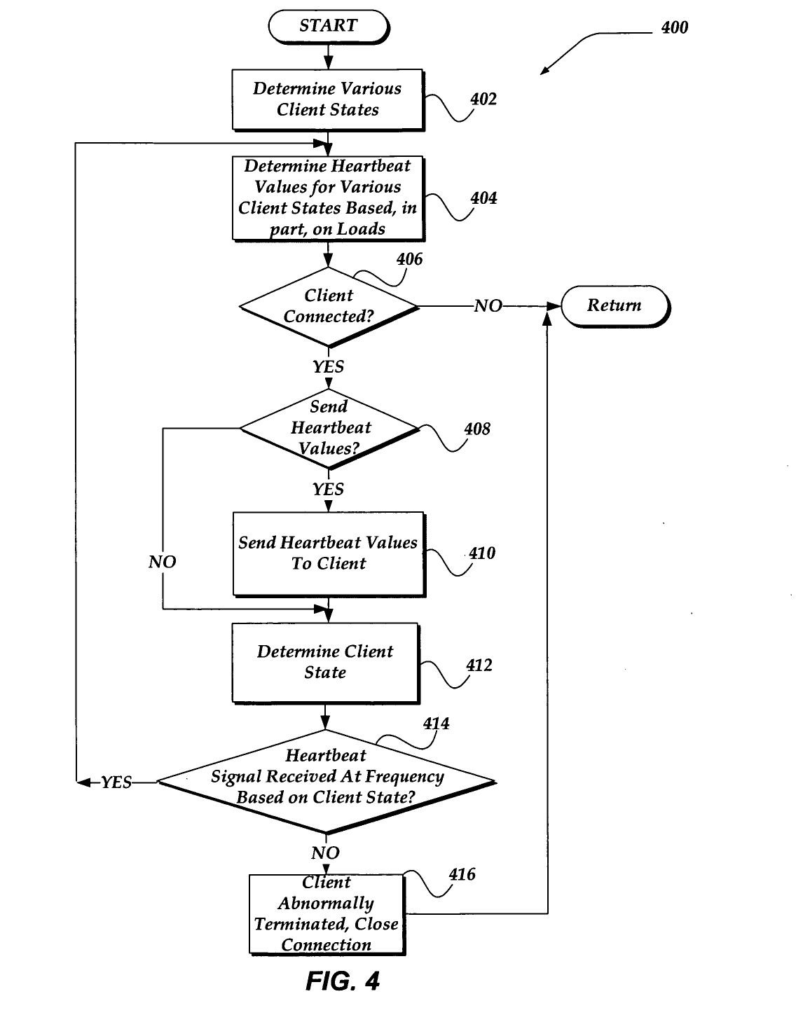

HSD 360 may also receive information indicating that the client has changed to a different client state, and based, in part, on the new client state, monitor receipt of a heartbeat signal from the client based on a heartbeat value associated with the new client state. In one embodiment, HSD 360 may employ a process substantially similar to process 400 described below in conjunction with FIG. 4 to perform at least some of its actions.

Generalized Operation

The operation of certain aspects of the invention will now be described with respect to FIG. 4-5. FIG. 4 illustrates a logical flow diagram generally showing one embodiment of a server process for managing a detection of an abnormal client termination based on a client state. Process 400 of FIG. 4 may, for example, be implemented within server device 300 of FIG. 3.

As shown in FIG. 4, process 400 begins, after a start block, at block 402 when various client states may be determined. In one embodiment, client states may be pre-determined. For example, a set of various client states to monitor may be provided that includes, for example, an idle state, a VOIP call session state, an IM session state, or the like. In one embodiment, a default client state may be determined that is intended to include client states not explicitly determined.

Processing then proceeds to block 404, where a heartbeat value is determined for each of the various client states. Such heartbeat values are usable to set a frequency in which a heartbeat signal is to be sent by a client. Determination of the heartbeat values may be based on a variety of factors, conditions, or the like. For example, in one embodiment, heartbeat values may be pre-determined based on default values, values selected based on engineering judgment, or the like. In another embodiment, the heartbeat values may be determined based on an environment, including a resource load, or a variety of other dynamic factors. Moreover, some heartbeat values may be based on dynamic factors, while other heartbeat factors may be static values. Thus, in one embodiment, at least some of the heartbeat values may dynamically change for a given client state over time, while others may be constant over a client connection.

Processing continues next to decision block 406 where a determination is made whether a client is connected. If a client has established a connection, processing flows to decision block 408; otherwise, processing returns to a calling process to perform other actions.

At decision block 408, a determination is made whether to send the heartbeat values to the client. Heartbeat values may be sent to the client when they change for a given client state, only at initial establishment of a client connection, periodically, or the like. In any event, heartbeat values are typically sent at least at the initial establishment of the client connection. Thus, if heartbeat values are to be sent, processing flows to block 410, where they are sent to the client. Otherwise, processing branches to block 412.

At block 412, a client state is determined. In one embodiment, client information may be sent by the client that may be employed to determine the client state. For example, in one embodiment, when a client sends a request for a VOIP call session, client state may be determined based on the receipt of the request, the establishment of the VOIP call, or the like.

Processing then moves to decision block 414, where monitoring is performed for a heartbeat signal from the client based on the client state. In one embodiment, the monitoring may employ a tolerance of acceptance around the heartbeat value for the client state, to minimize false positive. At decision block 414 at determination is made whether heartbeat signals are received within the frequency determined by the heartbeat value for the client state. In one embodiment, if two consecutive heartbeats are not received within the expected frequency, a determination may be made that the client has abnormally terminated its connection. If it is determined that the client has abnormally terminated its connection, processing flows to block 416; otherwise, processing loops back to block 404 to continue until the client connection is terminated (normally as detected at decision block 406 or abnormally as detected at decision block 414).

At block 416, when an abnormal termination is detected, client connections may be properly closed. For example, where the client was in a VOIP call state, and abnormal termination is detected, the server may perform actions that properly close the VOIP call, including, but not limited to, sending a message to one of the clients in the VOIP call, shutting down a connection, or the like. Processing then returns to the calling process to perform other actions.

FIG. 5 illustrates a logical flow diagram generally showing one embodiment of a client process for managing detection of an abnormal client termination based on a client state, in accordance with the present invention. Process 500 of FIG. 5 may be implemented, for example, in client devices 102-103 of FIG. 1.

Process 500 begins, after a start block, at block 502, when a network connection is established with a server. In a typical IM session, a client may establish a connection with an IM connection server, and a VOIP connection server, such as IM connection server 120 and SIP connection server 130 of FIG. 1, respectively. Such connections may include a TCP connection, or the like.

Processing then proceeds to block 504, where the client may receive various heartbeat values, each heartbeat value being associated with a different client state. Such client states may have been predetermined by a server based on a variety of mechanisms, including, a study of typical client states, supported client states, or the like. Moreover, receipt of the heartbeat values may occur after the connection with the server(s) are established. In one embodiment, at least one heartbeat value may be received by the client dynamically, in that the at least one heartbeat value may be sent more than once by the server(s). In addition, at least one heartbeat value may be received that is different for the same client state, replacing a previously sent heartbeat value for that client state.

Processing continues next to block 506, where a heartbeat value is selected based on a current client state (e.g., a first client state). The selected first heartbeat value associated with the first client state is then employed at block 508 to set a frequency for which a heartbeat signal is sent to the server(s).

Process 500 flows next to decision block 510, where a determination is made whether the client has changed its client state. A determination that the client has changed its state may be based on a variety of conditions. For example, when the client sends a SIP call request, that is received and acknowledged by the server, the client may be said to have changed its client state. When the client subsequently sends a SIP call cancel message that is similarly received and acknowledged by the server, the client is said to have again changed its client state. There are, of course a variety of other conditions that may result in a client state change, including, but not limited to sending a request for a SMS session, a request for a videoconference session, a request for streaming media, a transition to an inactive or idle mode by the client, or the like. In any event, if it is determined that the client has changed client state, processing loops back to block 504, where optionally updates to the heartbeat values may be received.

Alternatively, if at decision block 510, the client state is not changed, processing flows to decision block 512. At decision block 512, a determination is made whether the connection with the server(s) are normally terminated. A normal termination may occur where the client sends a message indicating that it is terminating the session. If the connection is normally terminated, processing returns to a calling process to perform other actions; otherwise, processing loops back to block 508.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A client device that is configured for use in managing an abnormal network termination, comprising:
a transceiver for receiving and for sending information over the network; and
program code that is arranged to perform actions comprising:
receiving, from a server, a first heartbeat value associated with a first client state, and a second heartbeat value associated with a second client state;
if the client device is in the first client state, employing the first heartbeat value to automatically modify a frequency for sending a heartbeat signal to the server; and
if the client device is in the second client state, employing the second heartbeat value to automatically modify a frequency for sending the heartbeat signal.

2. The client device of claim 1, wherein at least one of the first or the second client state further comprises at least one of an idle state, a VOIP session call, a videoconferencing session, or a streaming media state.

3. The client device of claim 1, wherein at least one of the first or the second heartbeat values is determined by the server based, in part, on a resource load.

4. The client device of claim 1, wherein the client device is a mobile device.

5. The client device of claim 1, wherein the program code is arranged to perform actions, further comprising:
if the client device transitions back to the first client state, employing the first heartbeat value to automatically modify the frequency for sending the heartbeat signal to the server.

6. The client device of claim 1, wherein receiving from the server the first and the second heartbeat values further comprises receiving a different heartbeat value for at least one of the first client state or the second client state at multiple times while the client device is in communication with the server.

7. A method for managing a network connection, comprising:
receiving a plurality of heartbeat values, each of the plurality of heartbeat values being associated with a different client state;
selecting a first heartbeat value from the plurality of heartbeat values based on a first client state;
sending a heartbeat signal at a frequency determined by the selected heartbeat value; and
if a client transitions to a second client state, selecting a second heartbeat value from the plurality of heartbeat values based on the second client state, and automatically using the second heartbeat value to modify a frequency for sending the heartbeat signal.

8. A modulated data signal that is configured to include program instructions for performing the method of claim 7.

9. The method of claim 7, further comprising:
if the client transitions back to the first client state, automatically using the first heartbeat value to determine the frequency for sending the heartbeat signal.

10. The method of claim 7, further comprising
receiving a different heartbeat value for one of the first client state or the second client state.

11. The method of claim 7, wherein receiving the plurality of heartbeat values further comprises receiving at least one heartbeat value that is further based on a resource load.

12. The method of claim 7, wherein the first client state or the second client state further comprises at least one of an idle state, a VOIP session call, an IM session state, a videoconferencing session, or a streaming media state.

13. The method of claim 7, wherein the plurality of heartbeat values are determined by at least one of a server or the client.

14. A server for use in detecting an abnormal client termination over a network, comprising:
a transceiver for receiving and sending information over the network;
a processor in communication with the transceiver; and
a memory in communication with the processor for use in storing data and machine instructions that causes the processor to perform a plurality of operations, including:
sending, to a client, a plurality of heartbeat values, each of the plurality of heartbeat values being associated with a different client state;
receiving, from the client, a heartbeat signal at a frequency selected by the client from the plurality of heartbeat values based on a first client state; and
if the client changes to a second client state, receiving from the client the heartbeat signal at a frequency automatically selected by the client from the plurality of heartbeat values based on the second client state.

15. The server of claim 14, the operations further comprising:
determining at least one heartbeat value in the plurality of heartbeat values based, in part, on a resource load.

16. The server of claim 14, the operations further comprising:
dynamically determining a different heartbeat value for at least one client state; and
sending the different heartbeat value to the client.

17. The server of claim 14, the operation further comprising:
if the client transitions back to the first client state, receiving the heartbeat signal at a frequency automatically selected by the client from the plurality of heartbeat values based on the first client state.

18. The server of claim 14, wherein the first client state or the second client state further comprises at least one of an idle state, a VOIP session state, an instant messaging state, an SMS state, a videoconferencing session, or a streaming media state.

19. A computer-readable medium having computer-executable instructions for performing steps for use in detecting an abnormal client connection termination over a network, the steps comprising:
if a client is in a first client state, sending a heartbeat signal at a frequency automatically determined by a first heartbeat value associated with the first client state; and
if the client is in a second client state, sending the heartbeat signal at a frequency automatically determined by a second heartbeat value associated with the second client state.

20. The computer-readable medium of claim 19, the steps further comprising:
if the client transitions back to the first client state, sending the heartbeat signal at the frequency automatically determined by the first heartbeat value associated with the first client state.

21. The computer-readable medium of claim 19, wherein the first client state or the second client state further comprises at least one of an idle state, a VOIP session call, a videoconferencing session, or a streaming media state.

22. The computer-readable medium of claim 19, wherein at least one of the first heartbeat value or the second heartbeat value is dynamically determined.

23. The computer-readable medium of claim 19, wherein at least one of the first heartbeat value or the second heartbeat value is determined based, at least in part, on a resource load.
